(19) United States
(12) Patent Application Publication
(10) Pub. No.: US 2026/0019786 A1
(43) Pub. Date: Jan. 15, 2026

(54) Method for Establishing a Wireless Communication Connection Between a Mobile Device and a Motor Vehicle

(71) Applicant: Bayerische Motoren Werke Aktiengesellschaft, Muenchen (DE)

(72) Inventor: Alaa MOURAD, Muenchen (DE)

(21) Appl. No.: 19/226,688

(22) Filed: Jun. 3, 2025

(30) Foreign Application Priority Data
Jul. 12, 2024 (DE) 10 2024 119 981.4

(51) Int. Cl. H04W 4/48; H04B 17/318; H04W 76/10; H04W 84/18

(52) U.S. Cl. CPC H04W 4/48; H04B 17/318; H04W 76/10; H04W 84/18

(57) ABSTRACT

A motor vehicle has at least two transceivers, each of which is configured for wireless communication with a mobile device. A method for establishing a wireless communication connection between a motor vehicle and the mobile device includes steps of receiving, by the transceivers, a signal emitted by the mobile device; determining signal strengths of the received signal at the transceivers; selecting one of the transceivers based on the signal strengths; and establishing of a wireless communication connection between the mobile device and the selected transceiver.

### CROSS REFERENCE TO RELATED APPLICATION

This application claims priority under 35 U.S.C. § 119 from German Patent Application No. 10 2024 119 981.4, filed Jul. 12, 2024, the entire disclosure of which is herein expressly incorporated by reference.

### BACKGROUND AND SUMMARY OF THE INVENTION

The present invention relates to a method for establishing a wireless communication connection between a mobile device and a motor vehicle. The present invention also relates to a control apparatus which is set up to establish a wireless communication connection between a mobile device and a motor vehicle.

For example, Bluetooth wireless technology can be used to establish a wireless communication connection. To establish a Bluetooth connection between two devices, a so-called discovery process can be carried out. To this end, one of the devices can emit a connection proposal (advertisement) on several frequencies at regular time intervals.

The other device can scan the frequencies for connection proposals at regular time intervals. When a connection proposal is discovered by the scanning device, connection information can be exchanged between the two devices. After the connection information has been exchanged, a Bluetooth connection can be established between the two devices. As long as there is a Bluetooth connection between the two devices, another Bluetooth connection cannot be established between these devices and other devices

Modern motor vehicles may have multiple devices that emit connection proposals independently of one another. If a connection proposal is found by a scanning device, the connection between these two devices is established according to the method described above. It may be that the connection between the two devices does not have the best possible connection quality.

One object on which the present invention is based is to provide an improved technique for establishing a wireless communication connection between a mobile device and a motor vehicle. The invention achieves this object by means of the subjects of the independent claims. The dependent claims represent preferred embodiments.

A motor vehicle has at least two transceivers, each of which is set up for wireless communication with a mobile

According to a first aspect of the present invention, a method for establishing a wireless communication connection between a motor vehicle and a mobile device comprises steps of reception, by means of the transceivers, of a signal emitted by the mobile device; determination of signal strengths of the received signal at the transceivers; selection of one of the transceivers based on the signal strengths; and establishing of a wireless communication connection between the mobile device and the selected transceiver.

Such a method has the advantage that the wireless communication connection is always possible with an increased signal strength so that the connection quality is increased.

A transceiver may be set up to convert a signal into a message, and vice versa. A transceiver may have a transmitter and receiver for wireless communication with the mobile device. A transceiver may have one or more antennas for transmitting and/or receiving wireless signals, such as radio signals. The antenna is usually a component mounted on a printed circuit board. The antenna typically has a width of less than or equal to 3 cm, a length of less than or equal to 3 cm and a height of less than or equal to 3 cm. The antenna may be located in any position in the motor vehicle. For example, the antenna may be located in a headliner in the interior of the motor vehicle. As an alternative or in addition, the antenna may be located in a vehicle door or in the region of the center console of the motor vehicle.

The mobile device may be in the form of a mobile telephone, in particular a smartphone or a smartband or a smartwatch.

The signal emitted by the mobile device can transport a message.

A technique described herein advantageously builds on a concept known as a digital vehicle key or Digital Car Key. A specification of the Digital Car Key is published by the Car Connectivity Consortium and is available at the time of writing this document in version 1.1.0 of Jul. 20, 2022. Reference is explicitly made here to this document.

A digital vehicle key can be presented via the wireless communication connection. Thus, for example, a motor vehicle to which the digital vehicle key is assigned can be automatically unlocked when the mobile device on which the digital vehicle key is stored communicates with a transceiver that can receive the signal based on connection information provided by another transceiver.

This can ensure that the signal strength at the transceivers is determined based on the same signal so as to be able to achieve an increased connection quality of the wireless communication connection between the mobile device and the motor vehicle.

The other transceiver may have received a connection response from the mobile device in response to a connection proposal. The connection proposal may include a Bluetooth “advertisement” of the motor vehicle or the control unit. The connection response may include a message, which is referred to as a “connection indication” in the Bluetooth standard.

The connection response may be a message and may be transmitted via a signal emitted by the mobile device. The connection response is preferably transported via the same signal emitted by the mobile device from which the signal strength is determined at the transceivers.

The connection response may include a prompt to respond to a transceiver.

The connection proposal may have been emitted by the other transceiver. This can ensure that a transceiver always receives a complete connection response to the connection proposal emitted thereby so that the quality of the wireless communication connection between the mobile device and the motor vehicle can be improved.

The connection information may include a connection interval. This enables a better connection to be established between a transceiver and the mobile device.

A connection interval is the time interval between two connection events, wherein a connection event comprises an exchange of data packets between two devices connected by means of a wireless communication connection, such as a transceiver and a mobile device.

The wireless communication connection can be established before a monitoring interval has elapsed, the monitoring interval being determined based on the connection interval.

This can ensure a compromise between quickly establishing a wireless communication connection between a transceiver and the mobile device and a wireless communication connection with an increased signal strength.

The monitoring interval may be an integer multiple of the connection interval. The transceivers can emit connection proposals independently of one another.

This can ensure that transceivers of the motor vehicle continue to emit connection proposals regardless of an existing wireless communication connection between the mobile device and one of the other transceivers, and are thus available for wireless communication connections with other mobile devices.

The transceivers can emit connection proposals independently of one another, in particular temporally independently of one another. The transceivers can emit connection proposals with a time offset.

A connection proposal may include an identification of the motor vehicle, and the connection proposals of the transceivers may include the same identification.

This can ensure that the wireless communication connection between the mobile device and the motor vehicle can be established, regardless of the transceiver of the motor vehicle using which the mobile device enters into the wireless communication connection.

The identification of the motor vehicle may be represented, for example, by a vehicle license plate number, a chassis number or by a vehicle identification number (VIN). As an alternative, an identification can be made, for example, with regard to a unique identifier of the control apparatus.

A transceiver that receives the signal determines the signal strength in the form of an RSSI value. The RSSI value can be generated by analog signal processing and can be provided in the form of a message from the transceiver to the control apparatus. This enables the control unit to better compare strengths of the signals received at the transceivers with one another. For example, the RSSI value can be expressed by means of a scaling factor in a power level with the unit decibel milliwatt (dBm).

The selected transceiver can transmit a transceiver response to the mobile device to establish the wireless communication connection. The transceiver response can be emitted in response to the connection indication and may contain information related to the connection indication. The wireless communication connection can be established via Bluetooth. The wireless communication connection can be established via Bluetooth Classic or Bluetooth Low Energy.

According to a further aspect of the present invention, the object is achieved by a control apparatus for use on board a motor vehicle, wherein the motor vehicle has at least two transceivers, each of which is set up for wireless communication with a mobile device, wherein the control apparatus comprises a processing device for controlling the transceivers, wherein the processing device is set up to receive, by means of the transceivers, a signal emitted by the mobile device, to determine signal strengths of the received signal at the transceivers, to select one of the transceivers based on the signal strengths and to establish a wireless communication connection between the mobile device and the selected transceiver.

Such a control apparatus has the advantage that a wireless communication connection between a motor vehicle and a mobile device can be established with always an increased signal strength.

The control apparatus may be connected to an on-board electrical system of the motor vehicle. The control apparatus may also be connected by means of a communication connection, in particular a data bus, to one or more further control apparatus on board the motor vehicle.

The processing device is preferably set up to partly or fully carry out a method described herein. The processing device may be of electronic design and include, for example, an integrated circuit, a programmable logic chip or a programmable microcomputer. The method may be implemented in the form of a configuration or as a computer program product with program code means for the processing device. The configuration or the computer program product may be stored on a non-transitory computer-readable data medium. Features or advantages of the method can be transferred to the apparatus, or vice versa.

According to a further aspect of the present invention, the object is achieved by a motor vehicle, wherein the motor vehicle has a previously described control apparatus.

The motor vehicle may include a passenger car with two, three, four or more seats. The seats may be arranged in one, two, three or more rows of seats.

The motor vehicle may also include a minibus, a small goods vehicle, a bus or a truck. The motor vehicle may include an electric vehicle. The motor vehicle may also include a hybrid vehicle. A hybrid vehicle may comprise two or more different energy conversion systems for providing the energy for moving the motor vehicle.

The invention will now be described in more detail with reference to the attached drawings, in which:

### BRIEF DESCRIPTION OF THE DRAWINGS

FIG. 1 schematically illustrates a system; and

FIG. 2 schematically illustrates a flowchart of a method.

### DETAILED DESCRIPTION OF THE DRAWINGS

In the description that follows, the same reference designations are used to denote identical components or identical features, such that a description given regarding a component with reference to one figure also applies to the other figures, such that a repeated description will be omitted. Furthermore, individual features that have been described in connection with one embodiment are also separately applicable to other embodiments.

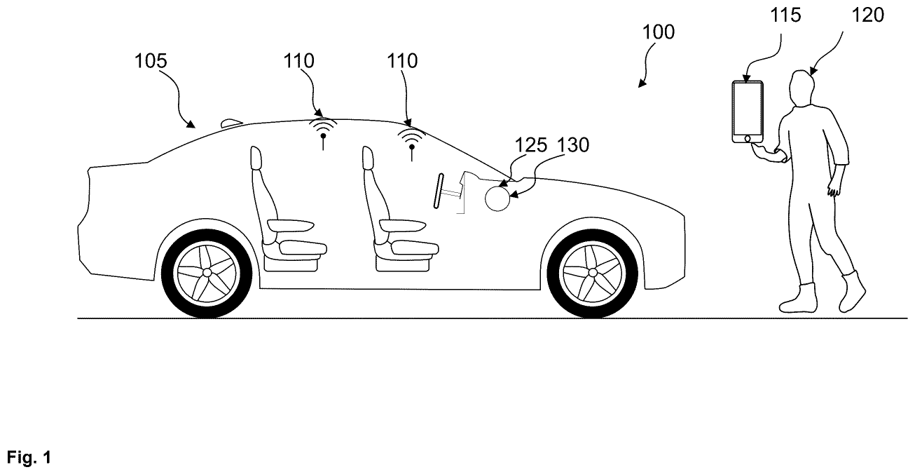

FIG. 1 shows a system 100, comprising a motor vehicle 105 and a mobile device 115. The motor vehicle 105 has two transceivers 110, wherein each of the transceivers 110 is set up in each case for wireless communication with a mobile device 115.

Each of the transceivers 110 may have a respective transmitter and receiver for wireless communication with the mobile device 115. Each of the transceivers 110 may have one or more antennas for transmitting and/or receiving wireless signals, such as radio signals. The antenna is usually a component mounted on a printed circuit board. The antenna typically has a width of less than or equal to 3 cm, a length of less than or equal to 3 cm and a height of less than or equal to 3 cm. The antenna may be located in any position in the motor vehicle 105. For example, the antenna may be located in a headliner in the interior of the motor vehicle 105. As an alternative or in addition, the antenna may be located in a vehicle door or in the region of the center console of the motor vehicle 105.

The mobile device 115 may be a mobile telephone or a smartphone or a smartband or a smartwatch. The motor vehicle 105 may have a control apparatus 125 for use on board the motor vehicle 105, wherein the control apparatus 125 may have a processing device 130 for controlling the transceivers 110. The control apparatus 125 may be a component part of the on-board electrical system of the motor vehicle 105.

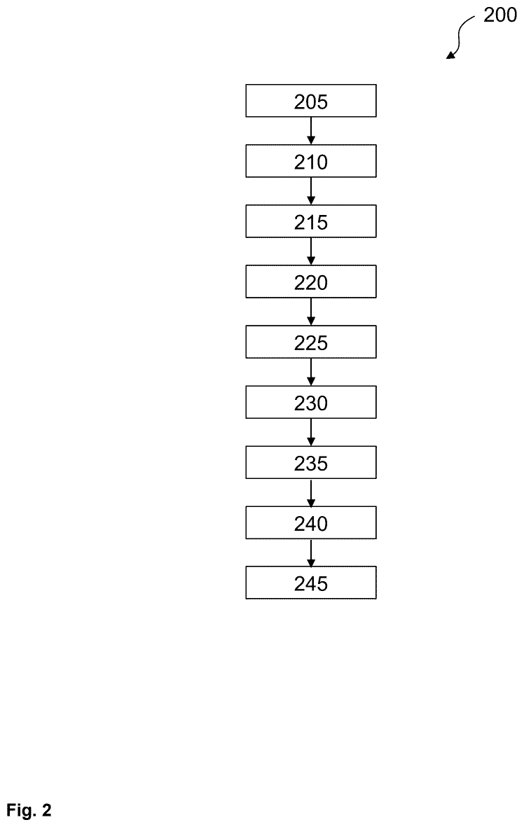

The processing device 130 may be set up to perform a method 200 illustrated in FIG. 2 in a flow diagram. For example, after the method 200 has been performed by means of the processing device 130, a digital vehicle key can be presented by means of the wireless communication connection between the motor vehicle 105 and the mobile device 115. Thus, for example, the motor vehicle 105 can be unlocked when a person 120 having the mobile device 115 approaches the motor vehicle 105 at a predetermined distance, for example 2 m.

The exemplary method 200 illustrated in FIG. 2 in a flow diagram is also described below with reference to FIG. 1. The method 200 may comprise a step 205 for emitting connection proposals, wherein the connection proposals can be emitted by means of the transceiver 110 of the motor vehicle 105. The transceivers 110 can emit the connection proposals independently of one another. The connection proposals emitted by the transceivers 110 may include connection information, such as a connection interval, for example.

The method 200 may include a step 210 for receiving a connection response emitted by the mobile device 115. The connection response of the mobile device 115 may have been received in response to a connection proposal of one of the transceivers 110. A transceiver 110 may have received the connection response of the mobile device 115 in response to a connection proposal emitted by the transceiver.

The method 200 may comprise a step 215 for providing connection information, wherein the connection information can be provided by the transceiver 110 that has received the connection response from the mobile device 115 in response to a connection proposal emitted by the transceiver.

The method 200 may comprise a step 220 for receiving, by means of the transceivers 110, a signal emitted by the mobile device 115. In this case, a transceiver 110 can receive the signal based on connection information provided by the transceiver 110 that has received the connection response of the mobile device 115 in response to its emitted connection proposal.

The method 200 may comprise a step 225 for determining signal strengths of the received signal at the transceivers 110. A transceiver 110 that receives the signal can determine the signal strength in the form of an RSSI value.

The method 200 may comprise a step 230 for selecting one of the transceivers 110 based on the signal strengths. For example, the transceiver 110 that received the signal with the highest signal strength in the form of the RSSI value can be selected.

The method 200 may include a step 235 for transmitting a transceiver response to the mobile device 115 for establishing the wireless communication connection.

The method 200 may include a step 240 for establishing a wireless communication connection between the mobile device 115 and the selected transceiver 110.

After a wireless communication connection is established between the selected transceiver 110 and the mobile device 115, the method 200 may include a step 245 for presenting a digital vehicle key by means of the wireless communication connection between the transceiver 110 and the mobile device 115. Thus, for example, the motor vehicle 105 can be unlocked when a person 120 having the mobile device 115 approaches the motor vehicle 105 at a predetermined distance, for example 2 m.

### REFERENCE SIGNS

100 System
105 Motor vehicle
110 Transceiver
115 Mobile device
120 Person
125 Control apparatus
130 Processing device
200 Method
205 Emission of connection proposals
210 Reception of a connection response emitted by the mobile device
215 Provision of connection information
220 Reception of a signal emitted by the mobile device
225 Determination of signal strengths of the received signal
230 Selection of one of the transceivers based on the signal strengths
235 Transmission of a transceiver response to the mobile device
240 Establishing of a wireless communication connection
245 Presentation of a digital vehicle key by means of the wireless communication connection

What is claimed is:

1. A method for establishing a wireless communication connection between a motor vehicle and a mobile device, wherein the motor vehicle has at least two transceivers, each of which is set up for wireless communication with the mobile device, the method comprising:
receiving, by the transceivers, a signal emitted by the mobile device;
determining signal strengths of the received signal at the transceivers;
selecting one of the transceivers based on the signal strengths; and
establishing a wireless communication connection between the mobile device and the selected transceiver.

2. The method according to claim 1, wherein one transceiver receives the signal based on connection information provided by another of the transceivers.

3. The method according to claim 2, wherein the another transceiver has received a connection response of the mobile device in response to a connection proposal.

4. The method according to claim 3, wherein the connection proposal was emitted by the another transceiver.

5. The method according to claim 2, wherein the connection information includes a connection interval.

6. The method according to claim 5, wherein the wireless communication connection is established before a monitoring interval has elapsed, the monitoring interval being determined based on the connection interval.

7. The method according to claim 1, wherein the transceivers emit connection proposals independently of one another.

8. The method according to claim 7, wherein each of the connection proposals includes an identification of the motor vehicle; and wherein the connection proposals of the transceivers include a same identification.

9. The method according to claim 1, wherein the transceivers that receive the signal determine the signal strength in the form of an RSSI value.

10. The method according to claim 1, wherein the selected transceiver transmits a transceiver response for establishing the wireless communication connection to the mobile device.

11. The method according to claim 1, wherein the wireless communication connection is established via Bluetooth.

12. A control apparatus for use on board a motor vehicle, wherein the motor vehicle has at least two transceivers, each of which is set up for wireless communication with a mobile device, the control apparatus comprising:
a processing device configured to control the transceivers;
wherein the processing device is configured to receive, via the transceivers, a signal emitted by the mobile device to
determine signal strengths of the received signal at the transceivers;
select one of the transceivers based on the signal strengths; and
establish a wireless communication connection between the mobile device and the selected transceiver.

13. A motor vehicle comprising a control apparatus according to claim 12.
